(19) United States
(12) Patent Application Publication
(10) Pub. No.: US 2026/0303762 A1
(43) Pub. Date: Oct. 1, 2026

(54) METHOD OF CONTROLLING OPTICAL SYSTEM

(71) Applicant: SEIKO EPSON CORPORATION, Tokyo (JP)

(72) Inventor: Shiki FURUI, Matsumoto-shi (JP)

(73) Assignee: SEIKO EPSON CORPORATION, Tokyo (JP)

(21) Appl. No.: 19/630,966

(22) Filed: Mar. 27, 2026

(30) Foreign Application Priority Data
Mar. 28, 2025 (JP) 2025-055391

(51) Int. Cl. H04N 9/31

(52) U.S. Cl. CPC H04N 9/3147; H04N 9/317; H04N 9/3185; H04N 9/3194

(57) ABSTRACT

A first and second normal vector which are candidates for a normal vector of a projection target object are calculated from a correspondence relationship in which plurality of first drawing pixels in one projector and plurality of second drawing pixels in another projector are associated with each other, one of the first and second normal vector is identified as normal vector of projection target object based on first difference as difference between first normal vector and optical axis of first projection lens as projection lens of the one projector, second difference as difference between second normal vector and optical axis of first projection lens, third difference as difference between first normal vector and optical axis of second projection lens which is projection lens of other projector, and fourth difference as difference between second normal vector and optical axis of the second projection lens.

The present application is based on, and claims priority from JP Application Serial Number 2025-055391, filed Mar. 28, 2025, the disclosure of which is hereby incorporated by reference herein in its entirety.

### BACKGROUND

### 1. Technical Field

The present disclosure relates to a method of controlling an optical system.

### 2. Related Art

JP-A-2024-65348 discloses a method of adjusting a projection image including acquiring plane parameters of a projection surface using a projective transformation matrix representing transformation from a first coordinate system in a first apparatus to a second coordinate system in a second apparatus. Examples of the plane parameters include a normal vector of the projection surface. Examples of the first apparatus include a projector that projects a projection image on the projection surface, and examples of the first coordinate system include a projector coordinate system that defines a position on the projection image. Examples of the second apparatus include a camera that captures an image of the projection surface, and examples of the second coordinate system include a camera coordinate system that defines a position on an image captured by the camera.

JP-A-2024-65348 is an example of the related art.

When the plane parameters of the projection surface are acquired using the projective transformation matrix, a plurality of solutions is obtained. In this case, it has not been possible to determine which solution is correct, and it has not been possible to correctly identify the plane parameters.

### SUMMARY

An aspect of a control method according to the present disclosure is a method of controlling an optical system including a first projection apparatus including a camera, a first projection lens, and a first drawing element including a plurality of first drawing pixels, and a second projection apparatus including a second projection lens and a second drawing element including a plurality of second drawing pixels, the method including: causing the first projection apparatus to project first structured light based on a first drawn image drawn on the first drawing element onto a target; acquiring a first captured image by causing the camera to image the first structured light projected on the target; causing the second projection apparatus to project second structured light based on a second drawn image drawn on the second drawing element onto the target; acquiring a second captured image by causing the camera to image the second structured light projected on the target; identifying, based on the first captured image and the second captured image, a correspondence relationship in which the plurality of first drawing pixels and the plurality of second drawing pixels are associated with each other; calculating, based on the correspondence relationship, a first normal vector as a candidate for a normal vector of the target and a second normal vector different from the first normal vector; calculating a first difference as a difference between the first normal vector and an optical axis of the first projection lens, and a second difference as a difference between the second normal vector and the optical axis of the first projection lens; and identifying, based on the first difference and the second difference, one of the first normal vector and the second normal vector as the normal vector of the target.

Further, a control method of another aspect of the present disclosure is a method of controlling an optical system including a projection apparatus including a projection lens and a drawing element including a plurality of drawing pixels, and a camera including an imaging lens and an imaging element including a plurality of imaging pixels, the method including: causing the projection apparatus to project structured light based on a drawn image drawn on the drawing element onto a target; acquiring a captured image by causing the camera to image the structured light projected on the target; identifying, based on the captured image, a correspondence relationship in which the plurality of drawing pixels and the plurality of imaging pixels are associated with each other; calculating, based on the correspondence relationship, a first normal vector as a candidate for a normal vector of the target and a second normal vector different from the first normal vector; calculating a first difference as a difference between the first normal vector and an optical axis of the projection lens, and a second difference as a difference between the second normal vector and the optical axis of the projection lens; and identifying, based on the first difference and the second difference, one of the first normal vector and the second normal vector as the normal vector of the target.

Further, a control method of still another aspect of the present disclosure is a method of controlling an optical system including a projection apparatus including a projection lens and a drawing element including a plurality of drawing pixels, a first camera including a first imaging lens and a first imaging element including a plurality of first imaging pixels, and a second camera including a second imaging lens and a second imaging element including a plurality of second imaging pixels, the method including: causing the projection apparatus to project structured light based on a drawn image drawn on the drawing element onto a target; acquiring a first captured image by causing the first camera to image the structured light projected on the target; acquiring a second captured image by causing the second camera to image the structured light projected on the target; identifying, based on the first captured image and the second captured image, a correspondence relationship in which the plurality of first imaging pixels and the plurality of second imaging pixels are associated with each other; calculating, based on the correspondence relationship, a first normal vector as a candidate for a normal vector of the target and a second normal vector different from the first normal vector; calculating a first difference as a difference between the first normal vector and an optical axis of the first imaging lens, and a second difference as a difference between the second normal vector and the optical axis of the first imaging lens; and identifying, based on the first difference and the second difference, one of the first normal vector and the second normal vector as the normal vector of the target.

### BRIEF DESCRIPTION OF THE DRAWINGS

FIG. 1 is a diagram showing a configuration example of an optical system 1 including a projector 10 that executes a processing method according to the present disclosure.

FIG. 2 is a diagram showing a configuration example of the projector 10.

FIG. 3 is a diagram showing a configuration example of a correction value calculator 155.

FIGS. 4A and 4B are each a diagram showing an installation example of the projector 10(1) and the projector 10(2) with respect to a projection target object SC.

FIGS. 5A and 5B are each a diagram illustrating a principle of the present disclosure.

FIG. 6 is a flowchart showing a flow of processing in a control method executed by a processing device 150 of the projector 10 in accordance with a program PR1.

FIG. 7 is a diagram illustrating Modified Example (1).

FIG. 8 is a flowchart showing a flow of processing in a control method in Modified Example (1).

### DESCRIPTION OF EMBODIMENTS

An embodiment described below is attached with various technically preferable limitations. However, the embodiment of the present disclosure is not limited to the aspect described below.

### A. Embodiment

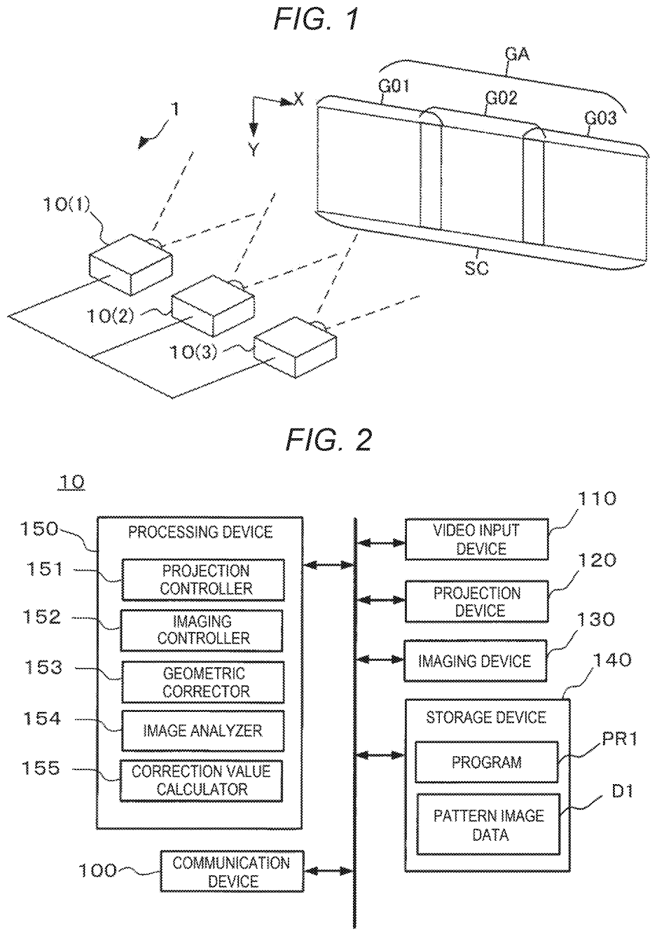

FIG. 1 is a diagram showing a configuration example of an optical system 1 including a projector 10(1) that executes a processing method according to the present disclosure. As shown in FIG. 1, the optical system 1 includes a projector 10(2) and a projector 10(3) in addition to the projector 10(1). Each of the projector 10(2) and the projector 10(3) is coupled to the projector 10(1) via, for example, a communication cable.

The optical system 1 is a system for implementing projection mapping by projecting an image onto a projection target object SC from each of the projector 10(1), the projector 10(2), and the projector 10(3). The projection target object SC is an example of a target in the present disclosure. As shown in FIG. 1, the projection target object SC in the present embodiment is, for example, a planar object such as a projection screen. In the optical system 1, the projector 10(1) projects an image G01 onto the projection target object SC. Further, in the optical system 1, the projector 10(2) projects an image G02 so as to overlap at least a part of the image G01 in an X direction in FIG. 1. Further, in the optical system 1, the projector 10(3) projects an image G03 so as to overlap at least a part of the image G02 and not to overlap the image G01 in the X direction in FIG. 1.

The projector 10(1), the projector 10(2), and the projector 10(3) all have the same configuration. Hereinafter, when it is unnecessary to distinguish the projector 10(1), the projector 10(2), and the projector 10(3), the projector 10(1), the projector 10(2), and the projector 10(3) are referred to as projector 10. Three projectors 10 are provided in the optical system 1 illustrated in FIG. 1. However, the number of projectors 10 provided in the optical system 1 may be two or may be four or more.

FIG. 2 is a diagram illustrating a configuration example of the projector 10. As illustrated in FIG. 2, the projector 10 includes a communication device 100, a video input device 110, a projection device 120, an imaging device 130, a storage device 140, and a processing device 150. Each of the communication device 100, the video input device 110, the projection device 120, the imaging device 130, and the storage device 140 is coupled to the processing device 150 via a bus (not illustrated in FIG. 2). The projector 10 includes, besides the elements illustrated in FIG. 2, an input device for receiving input operation of a user. However, since the input device is not closely related to the present disclosure, detailed explanation of the input device is omitted. Further, hereinafter, when it is necessary to distinguish the communication device 100 of the projector 10(1) from the communication device 100 of the projector 10(2), the former may be referred to as a communication device 100(1), and the latter may be referred to as a communication device 100(2). The same applies to the video input device 110, the projection device 120, the imaging device 130, the storage device 140, and the processing device 150, and the same applies to the communication device 100 and the like of the projector 10(3).

The communication device 100 includes a communication interface circuit. Another device is coupled to the communication device 100 via the communication cable explained above. In the present embodiment, the other device for the projector 10(1) is the projector 10(2) or the projector 10(3). Similarly, the other device for the projector 10(2) is the projector 10(1) or the projector 10(3). The other device for the projector 10(3) is the projector 10(2) or the projector 10(1). The communication device 100 delivers data received from the other device via the communication cable to the processing device 150 and, on the other hand, transmits data given from the processing device 150 to the other device.

A video supply device is coupled to the video input device 110 via a signal line such as a communication cable. In FIG. 1, illustration of the video supply device is omitted. In the present embodiment, an analog signal (hereinafter referred to as a video signal) representing a video to be projected by the projector 10 is input to the video input device 110 from the video supply device via the communication cable. Although detailed illustration is omitted in FIG. 1, the video input device 110 includes an A/D converter. The video input device 110 applies A/D conversion to the video signal input from the video supply device using the A/D converter and gives a digital signal (hereinafter referred to as video data), which is a result of the conversion, to the processing device 150. Hereinafter, the video represented by the video data is referred to as projection target video.

Although detailed illustration is omitted in FIG. 2, the projection device 120 includes a light source lamp, a display panel, and a projection lens. The display panel includes a plurality of drawing pixels arranged in a matrix. Specific examples of the display panel include a liquid crystal panel. The resolution of the display panel in the present embodiment is WUXGA(1920×1200) but may be other resolution. The display panel may be a digital mirror device. A video is drawn on the display panel by the processing device 150. Although details will be described later, examples of the video drawn on the display panel by the processing device 150 include an image as a projection target video of a measurement pattern (e.g., structured light such as a dot pattern) for measuring a three-dimensional shape of the projection target object SC, and a position and a posture of the projection device 120 with respect to the projection target object SC. Another example of the video drawn on the display panel by the processing device 150 is a corrected projection target video obtained by performing, on the projection target video, geometric correction or the like according to the measurement result using the measurement pattern. Examples of the geometric correction include correction of keystone distortion caused by image light obliquely projected from the projection device 120. Light emitted from the light source lamp is transmitted through the display panel to generate the image light modulated in accordance with the video drawn on the display panel is generated. The image light is projected onto the projection target object SC via the lens to thereby display a video represented by the image light described above on the projection target object SC.

The projection device 120(1) is an example of a first projection device in the present disclosure, and the projection device 120(2) is an example of a second projection device in the present disclosure. The projection device 120(1) is also an example of a first projection apparatus, and is an example of a projection apparatus. The projection device 120(2) is also an example of a second projection apparatus, and is an example of a projection apparatus. Further, the display panel in the projection device 120(1) is an example of a first drawing element in the present disclosure, and the plurality of drawing pixels constituting the display panel in the projection device 120(1) is an example of a first drawing pixel in the present disclosure. The display panel in the projection device 120(2) is an example of a second drawing element in the present disclosure, and the plurality of drawing pixels constituting the display panel in the projection device 120(2) is an example of a second drawing pixel in the present disclosure. The projection lens in the projection device 120(1) is an example of a first projection lens in the present disclosure, and the projection lens in the projection device 120(2) is an example of a second projection lens in the present disclosure.

The imaging device 130 includes an imaging element such as a complementary metal-oxide-semiconductor (CMOS) image sensor or a charge coupled device (CCD) image sensor, and an imaging lens. The imaging element includes a plurality of imaging pixels arranged in a matrix. In the present embodiment, the imaging device 130 images an imaging area under the control of the processing device 150. Light coming from the imaging area is transmitted through the imaging lens and is guided to the imaging element, and a signal according to the color and intensity of the incident light is output from each of the plurality of imaging pixels constituting the imaging element. A set of these signals serves as captured image data of a captured image. In the present embodiment, the projector 10(1) is installed so that a whole of the projection target object SC falls within the imaging area of the imaging device 130(1). The imaging device 130(1) captures an image in the imaging area under the control of the processing device 150(1) and gives the captured image data representing the captured image to the processing device 150(1). The imaging device 130 is an example of a camera in the present disclosure.

The storage device 140 includes a nonvolatile memory such as a flash read-only memory (ROM) and a volatile memory such as a random access memory (RAM). The nonvolatile memory of the storage device 140 stores a program PR1 for causing the processing device 150 to function as a control center of the projector 10 and pattern image data D1 representing the image of the measurement pattern explained above. The volatile memory of the storage device 140 is used by the processing device 150 as a work area when the program PR1 is executed.

The processing device 150 includes one or a plurality of processors. The processor includes, for example, a central processing unit (CPU). The processing device 150 is an example of a computer in the present disclosure. At the opportunity when the projector 10 is turned on, the processing device 150 reads the program PR1 from the nonvolatile memory to the volatile memory and starts executing the program PR1 read to the volatile memory. The processing device 150 operating in accordance with the program PR1 functions as a projection controller 151, an imaging controller 152, a geometric corrector 153, an image analyzer 154, and a correction value calculator 155.

The projection controller 151 controls the projection device 120 to project a video onto the projection target object SC. For example, when projecting an image of a measurement pattern onto the projection target object SC, the projection controller 151 reads the pattern image data D1 from the storage device 140 and draws the image represented by the pattern image data D1 on the display panel of the projection device 120 to thereby cause the projection device 120 to project the image of the measurement pattern onto the projection target object SC. When projecting a projection target video onto the projection target object SC, the projection controller 151 draws a corrected projection target video on the display panel of the projection device 120 to thereby cause the projection device 120 to project the corrected projection target video onto the projection target object SC. The corrected projection target video is generated by the geometric corrector 153. Although details will be described later, in the present embodiment, the projection controller 151 of the projector 10(1) projects the image of the measurement pattern onto the projection target object SC, and the projection controller 151 of the projector 10(2) projects the image of the measurement pattern onto the projection target object SC in response to an instruction from the projector 10(1) in a period in which no image is projected onto the projection target object SC from the projector 10(1). An image drawn on the display panel of the projection controller 151 of the projector 10(1) in accordance with the pattern image data D1 is an example of a first drawn image of the present disclosure, and an image of the measurement pattern projected based on the first drawn image is an example of first structured light in the present disclosure. An image drawn on the display panel of the projection controller 151 of the projector 10(2) in accordance with the pattern image data D1 is an example of a second drawn image of the present disclosure, and an image of the measurement pattern projected based on the second drawn image is an example of second structured light in the present disclosure.

The imaging controller 152 controls the imaging device 130 to image the projection target object SC. Although details will be described later, the imaging controller 152 of the projector 10(1) causes the imaging device 130 to image the projection target object SC in the state in which the first structured light described above is projected to thereby acquire a first captured image. Further, the imaging controller 152 of the projector 10(2) causes the imaging device 130 to image the projection target object SC in the state in which the second structured light described above is projected to thereby acquire a second captured image.

The geometric corrector 153 applies geometric correction corresponding to a correction value calculated by the correction value calculator 155 to video data given from the video input device 110 to generate corrected video data representing a corrected video. In the present embodiment, the processing device 150 operating in accordance with the program PR1 functions as the geometric corrector 153. However, the geometric corrector 153 may be implemented by an image processor. The image processor refers to a digital signal processor (DSP) specialized for image processing.

The image analyzer 154 analyzes an image represented by the image data acquired from the imaging device 130 to thereby identify, based on the first captured image and the second captured image, a correspondence relationship in which the plurality of first drawing pixels and the plurality of second drawing pixels are associated with each other. In a more detailed description, the image analyzer 154 first identifies, based on the first captured image, a first correspondence relationship representing a correspondence relationship between a two-dimensional coordinate system (hereinafter referred to as a first panel coordinate system) defining a position on the display panel (in other words, a position of each of the plurality of first drawing pixels) of the projection device 120(1) and a two-dimensional coordinate system (hereinafter referred to as a camera coordinate system) defining a position on the imaging element of the imaging device 130(1) (in other words, a position of each of the plurality of imaging pixels). In a three-dimensional coordinate system obtained by adding a Z axis, which is a coordinate axis along the projection direction, to the first panel coordinate system, a (0, 0, 1) direction is a direction of an optical axis of the first projection lens. In addition, in a three-dimensional coordinate system obtained by adding a Z axis, which is a coordinate axis along the imaging direction, to the camera coordinate system, a (0, 0, 1) direction is a direction of an optical axis of the imaging lens. An existing technique such as a structured light method is appropriately adopted in identification of the first correspondence relationship. Then, the image analyzer 154 identifies, based on the second captured image, a second correspondence relationship representing a correspondence relationship between a two-dimensional coordinate system (hereinafter referred to as a second panel coordinate system) defining a position on the display panel (in other words, a position of each of the plurality of second drawing pixels) in the projection device 120(2) and the camera coordinate system described above. In a three-dimensional coordinate system obtained by adding a Z axis, which is a coordinate axis along the projection direction, to the second panel coordinate system, a (0, 0, 1) direction is a direction of an optical axis of the second projection lens. An existing technique is also appropriately adopted in identification of the second correspondence relationship. Then, the image analyzer 154 associates the plurality of first drawing pixels and the plurality of second drawing pixels with each other via the camera coordinate system based on the first correspondence relationship and the second correspondence relationship to thereby identify a correspondence relationship (hereinafter referred to as a third correspondence relationship) in which the plurality of first drawing pixels and the plurality of second drawing pixels are associated with each other.

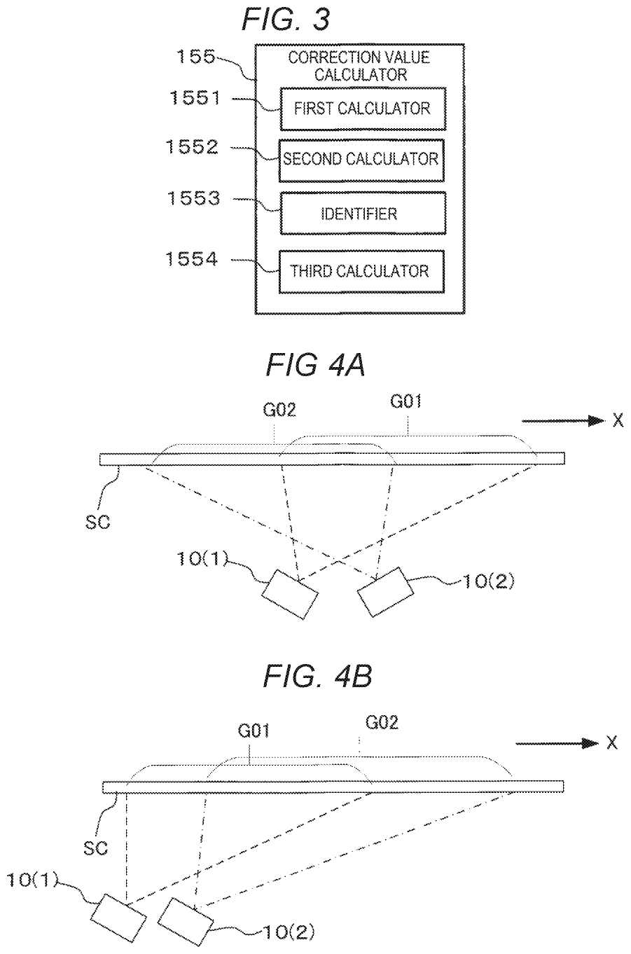

The correction value calculator 155 calculates a correction value for correcting the shape of the projection video based on the third correspondence relationship identified by the image analyzer 154. As illustrated in FIG. 3, the correction value calculator 155 includes a first calculator 1551, a second calculator 1552, an identifier 1553, and a third calculator 1554.

The first calculator 1551 calculates a projective transformation matrix for mutually transforming the first panel coordinate system and the second panel coordinate system based on the third correspondence relationship. It is sufficient for an existing technique to be appropriately used to calculate the projective transformation matrix based on the third correspondence relationship.

The second calculator 1552 performs singular value decomposition on the projective transformation matrix calculated by the first calculator 1551 to thereby calculate two sets of estimates related to the three-dimensional shape of the projection target object SC. The projection target object SC in the present embodiment is a planar object, and each of the two sets of estimates described above includes a position vector and a rotation matrix representing a relative positional relationship between one viewpoint and the other viewpoint in stereo measurement from two viewpoints different from each other, a distance to the projection target object SC, a candidate vector of a normal vector of the projection target object SC, and so on. In the present embodiment, the second calculator 1552 performs the singular value decomposition on the projective transformation matrix calculated by the first calculator 1551 to thereby calculate a first candidate vector and a second candidate vector that are candidates for the normal vector of the projection target object SC. The first candidate vector is an example of a first normal vector in the present disclosure, and the second candidate vector is an example of a second normal vector in the present disclosure.

As described above, when the three-dimensional measurement related to the shape of the projection target object SC is performed using the stereo measurement technology of a plurality of viewpoints, there is a problem that when the projection target object SC is a planar object, two sets of estimates are obtained, and the state of the projection target object SC cannot be uniquely estimated in the related art. One of these two sets of estimates corresponds to a state in which the arrangement of the projector 10(1) and the projector 10(2) in the X direction and the arrangement of the image G01 and the image G02 on the projection target object SC in the X direction are exchanged as shown in FIG. 4A. The other estimate corresponds to a state in which the arrangement of the projector 10(1) and the projector 10(2) in the X direction and the arrangement of the image G01 and the image G02 on the projection target object SC in the X direction are not exchanged as shown in FIG. 4B. However, it is not possible to determine which of the two estimation results is the actual installation state only from the measurement values by the imaging device 130, which is the reason for the problem.

In contrast, in the present disclosure, the problem described above is solved by adopting the estimate with which an angle between the optical axis of the projector 10 and the normal vector of the projection target object SC is smaller out of the two estimates obtained when the three-dimensional shape is estimated by the stereo measurement technology of the plurality of viewpoints with respect to the planar projection target object SC. The principle that the estimate according to the actual installation state can be selected by adopting the estimate with which the angle between the optical axis of the projector 10 and the normal vector of the projection target object SC is smaller is as follows.

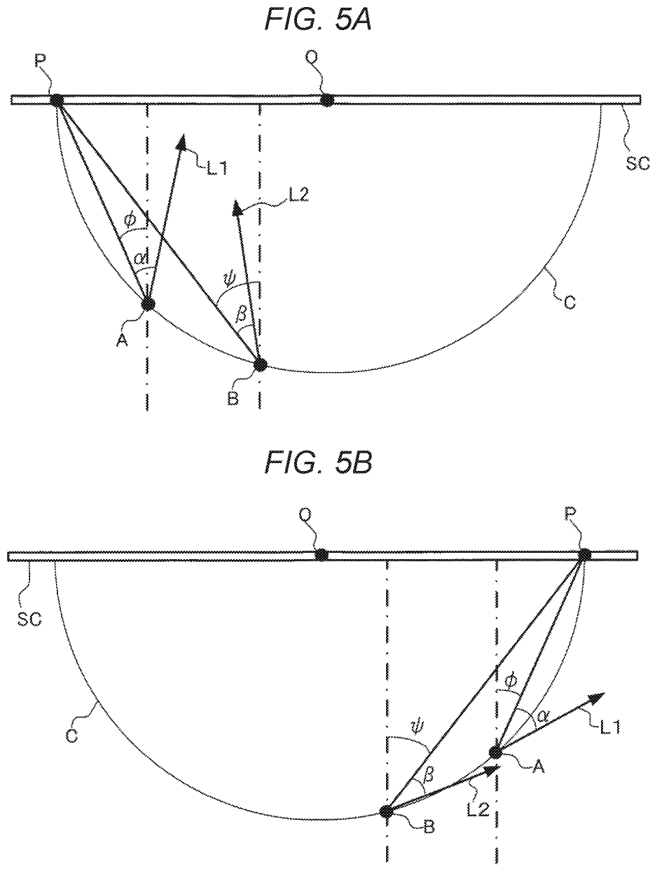

First, the stereo measurement related to the projection target object SC from two viewpoints of a viewpoint A and a viewpoint B is assumed. FIGS. 5A and 5B are each an overhead view of a space where the viewpoint A, the viewpoint B, and the projection target object SC are installed. A point O in FIGS. 5A and 5B is the center of a circle C that passes through the viewpoint A and the viewpoint B and whose center is located on the projection target object SC. Further, a point P in FIGS. 5A and 5B is one of the two intersections of the circle C and the projection target object SC.

An angle between a line segment AP and the normal line of the projection target object SC is denoted by φ, and an angle between a line segment BP and the normal line of the projection target object SC is denoted by ψ. In FIGS. 5A and 5B, the normal line of the projection target object SC is drawn by a dashed-dotted line. The two estimates of the three-dimensional measurement of the projection target object SC from the two viewpoints of the viewpoint A and the viewpoint B correspond to the respective states of FIG. 5A and FIG. 5B, and as is obvious from the comparison between FIG. 5A and FIG. 5B, the relationship between these two estimates is a relationship in which the four points of the viewpoint A, the viewpoint B, the point O, and the point P are exactly horizontally inverted.

Meanwhile, when the angle between the optical axis L1 of the projector installed at the viewpoint A and the line segment AP is denoted by α and the angle between the optical axis L2 of the projector installed at the viewpoint B and the line segment BP is denoted by β, the angle α and the angle β are not horizontally inverted between the two estimates. Accordingly, the angle between the normal line of the projection target object SC and the optical axis L1 is α−φ in one estimate and is α+φ in the other estimate. Similarly, the angle between the normal line of the projection target object SC and the optical axis L2 is β−ψ in one estimate, and is β+ψ in the other estimate.

As described above, the angle between the optical axis L1 and the normal line of the projection target object SC and the angle between the optical axis L2 and the normal line of the projection target object SC are each a value greatly different between the two estimates. The projector is generally installed so as to face the projection target object SC. As the degree to which the projector directly faces the projection target object SC increases, the angle between the optical axis of the projector and the normal line of the projection target object SC approaches 0°. That is, as the degree to which the projector directly faces the projection target object SC increases, the magnitude of the angle between the optical axis of the projector and the normal line of the projection target object SC decreases. Therefore, by adopting the estimate with which the angle between the optical axis of the projector 10 and the normal vector of the projection target object SC is smaller, it is possible to select the estimate according to the actual installation state.

The principle in the background of the present disclosure is as described above.

As described above, in the present embodiment, the projection device 120 in the projector 10(1) substantially directly faces the projection target object SC, and the projection device 120 in the projector 10(2) also substantially directly faces the projection target object SC. In the present embodiment, based on the principle described above, the identifier 1553 identifies the normal vector of the projection target object SC by adopting the estimate with which the angle between the optical axis of the projector 10 and the candidate vector of the projection target object SC is smaller. The optical axis of the projector 10 refers to the optical axis of the projection lens in the projection device 120. In the present embodiment, a (0,0,1) direction in the panel coordinate system is the direction of the optical axis of the projector 10. The identifier 1553, first, calculates a first difference that is a difference between the first candidate vector and the optical axis of the first projection lens, a second difference that is a difference between the second candidate vector and the optical axis of the first projection lens, a third difference that is a difference between the first candidate vector and the optical axis of the second projection lens, and a fourth difference that is a difference between the second candidate vector and the optical axis of the second projection lens. The first difference is, for example, an angle θ_{A} between the first candidate vector and the optical axis of the first projection lens. The first difference is calculated by calculating the inverse cosine of the inner product of a unit vector along the first candidate vector and a unit vector along the optical axis of the first projection lens. The second difference is, for example, an angle θ_{B} between the second candidate vector and the optical axis of the first projection lens. The third difference is, for example, an angle φ_{A} between the first candidate vector and the optical axis of the second projection lens. The fourth difference is, for example, an angle φ_{B} between the second candidate vector and the optical axis of the second projection lens. The method of calculating each of the second difference, the third difference, and the fourth difference is substantially the same as the method of calculating the first difference. In the present embodiment, each of the first difference, the second difference, the third difference, and the fourth difference is an index related to an angle, but is not limited thereto. For example, the aspect of each of the first difference, the second difference, the third difference, and the fourth difference is not particularly limited as long as the difference is an index capable of expressing the degree of coincidence or the degree of non-coincidence between the direction of each of the first candidate vector, the second candidate vector, the third candidate vector, and the fourth candidate vector and the direction of the optical axis, such as the length of a perpendicular drawn from the tip of the candidate vector to the optical axis.

Then, the identifier 1553 identifies one of the first candidate vector and the second candidate vector as the normal vector of the projection target object SC based on the first difference, the second difference, the third difference, and the fourth difference. In a more detailed description, when the magnitude of the first difference or the magnitude of the third difference is the largest of the magnitude of the first difference, the magnitude of the second difference, the magnitude of the third difference, and the magnitude of the fourth difference, the identifier 1553 identifies the second candidate vector as the normal vector of the target. Conversely, when the magnitude of the second difference or the magnitude of the fourth difference is the largest, the identifier 1553 identifies the first candidate vector as the normal vector. The magnitude of the first difference refers to an absolute value of the first difference. Similarly, the magnitude of the second difference refers to an absolute value of the second difference, the magnitude of the third difference refers to an absolute value of the third difference, and the magnitude of the fourth difference refers to an absolute value of the fourth difference. The reason that the largest one of the first difference, the second difference, the third difference, and the fourth difference is focused on will be described below. For example, when attention is supposedly paid to the smallest one of the first difference, the second difference, the third difference, and the fourth difference, the first difference and the fourth difference are zero when the projector 10(1) is incidentally installed to directly face the projection target object SC and the projector 10(2) is installed obliquely to the projection target object SC, and the magnitude of the fourth difference is smaller than the magnitude of the first difference, the principle described above cannot be applied as it is. Specifically, an erroneous determination may occur in which the normal vector when the projector 10(2) is regarded as directly facing the projection target object SC is selected despite the fact that the projector 10(2) is actually installed obliquely with respect to the projection target object SC.

The third calculator 1554 calculates a correction value for correcting the shape of the projection video based on the angle between the normal vector identified by the identifier 1553 and the optical axis of the first projection lens, and provides the correction value to the geometric corrector 153. As described above, the geometric corrector 153 performs geometric correction according to the correction value on the video data provided from the video input device 110, and generates the corrected video data representing the corrected video. Further, the projection controller 151 causes the projection device 120 to project the corrected projection target video onto the projection target object SC by drawing the corrected projection target video on the display panel of the projection device 120. Thus, the projection video on which the geometric correction according to the orientation of the projector 10 with respect to the projection target object SC is performed is displayed on the projection target object SC.

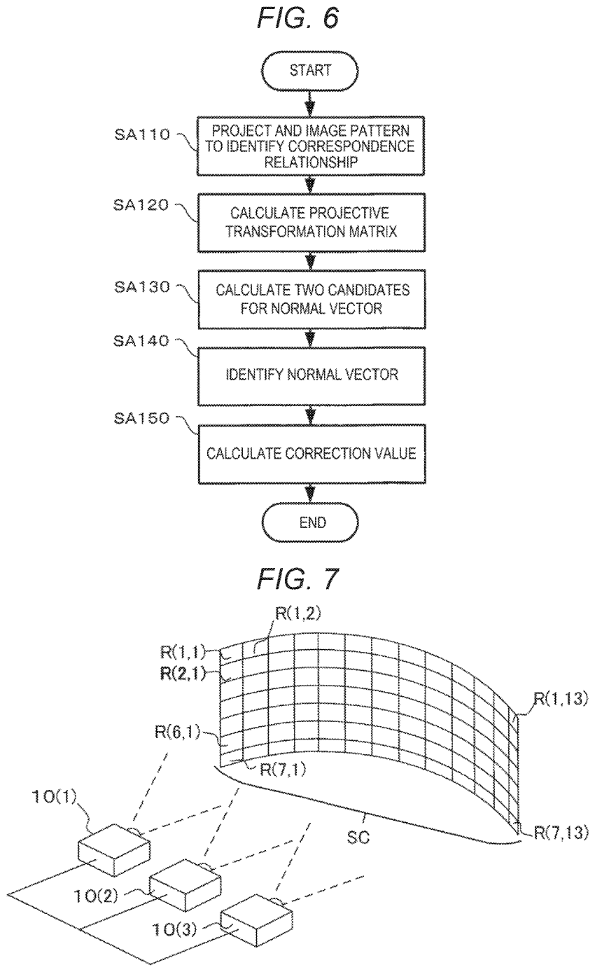

Further, in the projector 10(1), the processing device 150 operating in accordance with the program PR1 executes the control method according to the present disclosure in response to receiving, from the input device, a signal indicating that an input operation instructing execution of geometric correction has been performed. FIG. 6 is a flowchart illustrating a flow of processing in the control method according to the present disclosure. As shown in FIG. 6, the processing method includes processing in steps SA110, SA120, SA130, SA140, and SA150.

In step SA110, the processing device 150 operating in accordance with the program PR1 first functions as the projection controller 151 and the imaging controller 152. In the step SA110, the processing device 150 operating in accordance with the program PR1 functions as the projection controller 151 and causes the projection device 120 to project an image of a measurement pattern onto the projection target object SC and, on the other hand, functions as the imaging controller 152 and causes the imaging device 130 to image the projection target object SC onto which the image of the pattern is projected. As a result, the first captured image described above is acquired.

When the acquisition of the first captured image is completed, the processing device 150 of the projector 10(1) communicates with the projector 10(2) using the communication device 100 to instruct the projector 10(2) to project the image of the measurement pattern on the projection target object SC. When receiving that instruction, the processing device 150 of the projector 10(2) functions as the projection controller 151 and projects the image of the measurement pattern onto the projection target object SC. After transmitting the instruction described above to the projector 10(2), the processing device 150 of the projector 10(1) functions as the imaging controller 152 and causes the imaging device 130 to image the projection target object SC in a state in which the image of the measurement pattern is projected from the projector 10(2). As a result, the second captured image is acquired.

When the acquisition of the second captured image is completed, the processing device 150 functions as the image analyzer 154, and identifies, based on the first captured image and the second captured image, the correspondence relationship (i.e., the third correspondence relationship described above) in which the plurality of first drawing pixels and the plurality of second drawing pixels are associated with each other.

In steps SA120 to SA150, the processing device 150 operating in accordance with the program PR1 functions as the correction value calculator 155. In step SA120, the processing device 150 functions as the first calculator 1551 to calculate the projective transformation matrix for mutually transforming the first panel coordinate system and the second panel coordinate system based on the third correspondence relationship identified in step SA110.

In step SA130, the processing device 150 operating in accordance with the program PR1 functions as the second calculator 1552 to calculate the first candidate vector and the second candidate vector that are candidates for the normal vector of the projection target object SC by performing the singular value decomposition on the projective transformation matrix calculated in step SA120.

In step SA140, the processing device 150 operating in accordance with the program PR1 functions as the identifier 1553. In step SA140, the processing device 150 first calculates a first difference that is a difference between the first candidate vector and the optical axis of the first projection lens, a second difference that is a difference between the second candidate vector and the optical axis of the first projection lens, a third difference that is a difference between the first candidate vector and the optical axis of the second projection lens, and a fourth difference that is a difference between the second candidate vector and the optical axis of the second projection lens. Subsequently, the processing device 150 identifies one of the first candidate vector and the second candidate vector as the normal vector of the projection target object SC based on the first difference, the second difference, the third difference, and the fourth difference. As described above, in the present embodiment, when the magnitude of the first difference or the magnitude of the third difference is the largest of the magnitude of the first difference, the magnitude of the second difference, the magnitude of the third difference, and the magnitude of the fourth difference, the processing device 150 identifies the second candidate vector as the normal vector of the target. Conversely, when the magnitude of the second difference or the magnitude of the fourth difference is the largest, the processing device 150 identifies the first candidate vector as the normal vector.

In step SA150, the processing device 150 functions as the third calculator 1554. In step SA150, the processing device 150 calculates a correction value for correcting the shape of the projection video based on the angle between the normal vector identified in step SA140 and the optical axis of the first projection lens. Thereafter, the processing device 150 functions as the geometric corrector 153, performs the geometric correction according to that correction value on the video data provided from the video input device 110, generates the corrected video data representing the corrected video, functions as the projection controller 151, draws the corrected projection target video on the display panel of the projection device 120 to thereby cause the projection device 120 to project the corrected projection target video onto the projection target object SC. Thus, the projection video on which the geometric correction according to the orientation of the projector 10 with respect to the projection target object SC is performed is displayed on the projection target object SC.

According to the present embodiment, even when both the first candidate vector and the second candidate vector are calculated as the candidates for the normal vector of the projection target object SC, it is possible to identify the appropriate normal vector applying the fact that the projection device 120 in the projector 10(1) and the projection device 120 in the projector 10(2) are disposed so as to face the projection target object SC as much as possible (i.e., so as to directly face the projection target object SC).

### B. Modifications

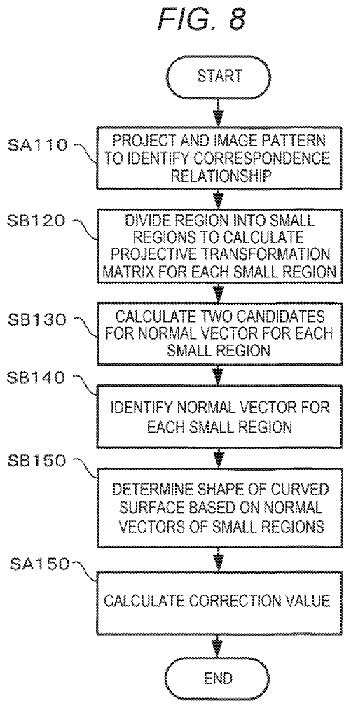

The embodiment described above can be modified as follows.
(1) The projection target object SC in the embodiment described above is a planar object. However, the projection target object SC may be an object at least a part of which is curved, or may be a curved object as shown in FIG. 7. When the projection target object SC is a curved object as shown in FIG. 7, it is conceivable to cause the processing device 150 to execute a control method shown in FIG. 8 instead of the control method shown in FIG. 6. In FIG. 8, the same processing as in FIG. 6 is denoted by the same reference symbol as in FIG. 6. As is obvious from comparison between FIGS. 8 and 6, the control method illustrated in FIG. 8 is different from the control method illustrated in FIG. 6 in that the control method illustrated in FIG. 8 includes processing in steps SB120 to SB150 instead of the processing in steps SA120 to SA140.

In steps SB120 to SB150 in FIG. 8, the processing device 150 functions as the correction value calculator 155 similarly to the case in the embodiment described above. In step SB120, the processing device 150 first divides a region corresponding to the projection target object SC in the captured image of the imaging device 130 into a plurality of small regions R(i,j) each of which can be regarded as a substantially flat surface. In the example shown in FIG. 7, the region corresponding to the projection target object SC is divided into 7×13 small regions R(i,j). That is, i is an integer no smaller than 1 and no larger than 7, and j is an integer no smaller than 1 and no larger than 13. The expression that the small region R(i,j) can be regarded as a substantially flat surface means that the width and the height of the small region R(i,j) are sufficiently smaller than the curvature radius of the small region R(i,j), and more specifically, means that the ratio of the width of the small region R(i,j) to the curvature radius in the width direction of the small region R(i,j) is no higher than a predetermined value, and the ratio of the height of the small region R(i,j) to the curvature radius in the height direction of the small region R(i,j) is no higher than a predetermined value. Then, the processing device 150 functions as the first calculator 1551 to calculate a projective transformation matrix for mutually transforming the first panel coordinate system and the second panel coordinate system in the small region R(i,j) based on the third correspondence relationship identified in step SA110. That is, in step SB120, 7×13 projective transformation matrices are calculated.

In step SB130, the processing device 150 functions as the second calculator 1552 to perform the singular value decomposition on each of the 7×13 projective transformation matrices calculated in step SB120 to thereby calculate 7×13 pairs of the first candidate vector and the second candidate vector that are candidates for the normal vector. That is, in step SB130, the first candidate vector and the second candidate vector are calculated for each small region R(i,j).

In step SB140, the processing device 150 functions as the identifier 1553. In step SB140, the processing device 150 identifies a normal vector for each small region R(i,j). The method of identifying the normal vector for each small region R(i,j) is substantially the same as that in the embodiment described above. For example, the normal vector for the small region R(1,1) is identified as follows. The processing device 150 first calculates a first difference that is a difference between the first candidate vector and the optical axis of the first projection lens, a second difference that is a difference between the second candidate vector and the optical axis of the first projection lens, a third difference that is a difference between the first candidate vector and the optical axis of the second projection lens, and a fourth difference that is a difference between the second candidate vector and the optical axis of the second projection lens for the small region R(1,1). Then, the processing device 150 identifies one of the first candidate vector and the second candidate vector as the normal vector of the small region R(1,1) based on the first difference, the second difference, the third difference, and the fourth difference. Specifically, when the magnitude of the first difference or the magnitude of the third difference is the largest of the magnitude of the first difference, the magnitude of the second difference, the magnitude of the third difference, and the magnitude of the fourth difference, the processing device 150 identifies the second candidate vector as the normal vector of the small region R(1,1). Conversely, when the magnitude of the second difference or the magnitude of the fourth difference is the largest, the processing device 150 identifies the first candidate vector as the normal vector of the small region R(1,1). Since the normal vector is identified for each of the 7×13 small regions R(i,j), the 7×13 normal vectors are identified in step SB140.

In step SB150, the processing device 150 functions as the identifier 1553. In step SB150, the processing device 150 identifies the normal vector of the projection target object SC by combining the 7×13 normal vectors identified in step SB140 into one vector. Specifically, the processing device 150 identifies the shape of the curved surface based on the 7×13 normal vectors using a known method. Further, it is also possible to adopt an aspect in which the normal vector of the projection target object SC is calculated by a general three-dimensional restoration method by obtaining an accurate positional relationship between the projectors 10 by performing statistical processing such as obtaining an average value on the positional relationship (translation and rotation) between the plurality of projectors 10. In step SA150 subsequent to step SB150, the processing device 150 functions as the third calculator 1554 and calculates a correction value for correcting the shape of the projection video based on the shape of the curved surface measured in step SB150 and an optical axis vector of the first projection lens.
(2) In the embodiments described above, the identifier 1553 identifies one of the first candidate vector and the second candidate vector as the normal vector of the projection target object SC focusing attention on the largest one in magnitude of the first difference, the second difference, the third difference, and the fourth difference. However, it is also possible for the identifier 1553 to identify one of the first candidate vector and the second candidate vector as the normal vector of the projection target object SC focusing attention on the smallest one in magnitude of the first difference, the second difference, the third difference, and the fourth difference. Specifically, the identifier 1553 may identify the first candidate vector as the normal vector of the projection target object SC when the magnitude of the first difference or the magnitude of the third difference is the smallest, and may identify the second candidate vector as the normal vector of the projection target object SC when the magnitude of the second difference or the magnitude of the fourth difference is the smallest. Further, when the projection device 120 in the projector 10(1) substantially directly faces the projection target object SC and the degree to which the projection device 120 in the projector 10(2) directly faces the projection target object SC is lower than the degree to which the projection device 120 in the projector 10(1) directly faces the projection target object SC, the identifier 1553 may identify one of the first candidate vector and the second candidate vector as the normal vector of the projection target object SC based on the first difference and the second difference. Specifically, an aspect that the second candidate vector is identified as the normal vector of the projection target object SC when the magnitude of the second difference is smaller than the magnitude of the first difference, and the first candidate vector is identified as the normal vector of the projection target object SC when the magnitude of the first difference is smaller than the magnitude of the second difference is conceivable. Further, in order to avoid the erroneous determination described above, it is also possible for the identifier 1553 to identify the first candidate vector as the normal vector of the projection target object SC when the magnitude of the second difference is larger than the magnitude of the first difference, and to identify the second candidate vector as the normal vector of the projection target object SC when the magnitude of the first difference is larger than the magnitude of the second difference.

That is, the control method according to the present disclosure is a method of controlling the optical system including the first projection device including the camera, the first projection lens, and the first drawing element including the plurality of first drawing pixels, and the second projection device including the second projection lens, and the second drawing element including the plurality of second drawing pixels, and sufficiently includes: causing the first projection device to project first structured light based on a first drawn image drawn on the first drawing element onto a target; acquiring a first captured image by causing the camera to image the first structured light projected on the target; causing the second projection device to project second structured light based on a second drawn image drawn on the second drawing element onto the target; acquiring a second captured image by causing the camera to image the second structured light projected on the target; identifying, based on the first captured image and the second captured image, a correspondence relationship in which the plurality of first drawing pixels and the plurality of second drawing pixels are associated with each other; calculating, based on the correspondence relationship, a first normal vector as a candidate for a normal vector of the target and a second normal vector different from the first normal vector; calculating a first difference as a difference between the first normal vector and an optical axis of the first projection lens, and a second difference as a difference between the second normal vector and the optical axis of the first projection lens; and identifying, based on the first difference and the second difference, one of the first normal vector and the second normal vector as the normal vector of the target.
(3) In the embodiment described above, the first calculator 1551 calculates the projective transformation matrix for mutually transforming the first panel coordinate system and the second panel coordinate system, and the second calculator 1552 calculates the first candidate vector and the second candidate vector by performing the singular value decomposition on the projective transformation matrix. However, the first calculator 1551 may calculate a projective transformation matrix for mutually transforming the first panel coordinate system and the camera coordinate system, and the second calculator 1552 may calculate the first candidate vector and the second candidate vector by performing the singular value decomposition on the projective transformation matrix for mutually transforming the first panel coordinate system and the camera coordinate system. In this aspect, the identifier 1553 may first calculate a first difference, which is a difference between the first candidate vector and the optical axis of the projection lens, and a second difference, which is a difference between the second candidate vector and the optical axis of the projection lens, and identify the normal vector of the projection target object SC by selecting one of the first candidate vector and the second candidate vector based on the first difference and the second difference. Specifically, when the magnitude of the first difference is larger than the magnitude of the second difference, the identifier 1553 identifies the second candidate vector as the normal vector of the target, and conversely, when the magnitude of the second difference is larger than the magnitude of the first difference, the identifier 1553 identifies the first candidate vector as the normal vector. According to the present aspect as well, even when both the first candidate vector and the second candidate vector are calculated as the candidates for the normal vector of the projection target object SC, an appropriate normal vector can be identified. In the present aspect, the projection of the pattern by the projector 10(2) and the imaging of the projection target object SC in the state in which the pattern is projected are unnecessary.

That is, the control method of the present disclosure may be a method of controlling an optical system (e.g., the projector 10(1)) including the projection device 120 including the projection lens and the drawing element including the plurality of drawing pixels, and the imaging device 130 including the imaging lens and the imaging element including the plurality of imaging pixels, and may be a control method including: causing the projection device 120 to project the structured light based on the drawn image drawn on the drawing element onto the projection target object SC; acquiring the captured image by causing the imaging device 130 to image the structured light projected on the projection target object SC; identifying, based on the captured image, a correspondence relationship in which the plurality of drawing pixels and the plurality of imaging pixels are associated with each other; calculating, based on the correspondence relationship, a first normal vector as a candidate of a normal vector of the projection target object SC and a second normal vector different from the first normal vector; calculating a first difference as a difference between the first normal vector and the optical axis of the projection lens, and a second difference as a difference between the second normal vector and the optical axis of the projection lens; and identifying, based on the first difference and the second difference, one of the first normal vector and the second normal vector as the normal vector of the projection target object SC.
(4) In the embodiment described above, the first calculator 1551 calculates the projective transformation matrix for mutually transforming the first panel coordinate system and the second panel coordinate system, and the second calculator 1552 calculates the first candidate vector and the second candidate vector by performing the singular value decomposition on the projective transformation matrix. However, the first calculator 1551 may calculate a projective transformation matrix for mutually transforming a camera coordinate system (hereinafter referred to as a first camera coordinate system) related to the imaging device 130 (hereinafter referred to as a first camera) of the projector 10(1) and a camera coordinate system (hereinafter referred to as a second camera coordinate system) related to the imaging device 130 (hereinafter referred to as a second camera) of the projector 10(2), and the second calculator 1552 may calculate the first candidate vector and the second candidate vector by performing the singular value decomposition on the projective transformation matrix for mutually transforming the first camera coordinate system and the second camera coordinate system. In this aspect, the identifier 1553 first calculates a first difference as a difference between the first candidate vector and the optical axis of the imaging lens (hereinafter referred to as a first imaging lens) of the first camera and a second difference as a difference between the second candidate vector and the optical axis of the first imaging lens. Further, the identifier 1553 calculates a third difference as a difference between the first candidate vector and an optical axis of an imaging lens (hereinafter referred to as a second imaging lens) of the imaging device 130 of the projector 10(2), and a fourth difference as a difference between the second candidate vector and the optical axis of the second imaging lens. The identifier 1553 may identify the normal vector of the projection target object SC by selecting one of the first candidate vector and the second candidate vector based on the first difference, the second difference, the third difference, and the fourth difference. Specifically, the identifier 1553 identifies the second candidate vector as the normal vector of the target when the magnitude of the first difference or the magnitude of the third difference is the largest, and conversely, identifies the first candidate vector as the normal vector when the magnitude of the second difference or the magnitude of the fourth difference is the largest. According to the present aspect as well, even when both the first candidate vector and the second candidate vector are calculated as the candidates for the normal vector of the projection target object SC, an appropriate normal vector can be identified. In the present aspect, the projection of the pattern by the projector 10(2) is unnecessary, and it is sufficient for the first captured image and the second captured image to be acquired by the imaging device 130 of each of the projector 10(1) and the projector 10(2) imaging the projection target object SC onto which the pattern image is projected from the projector 10(1). Further, similarly to the modified example (2), when the imaging device 130 in the projector 10(1) substantially directly faces the projection target object SC and the degree to which the imaging device 130 in the projector 10(2) directly faces the projection target object SC is lower than the degree to which the imaging device 130 in the projector 10(1) directly faces the projection target object SC, the identifier 1553 may identify one of the first candidate vector and the second candidate vector as the normal vector of the projection target object SC based on the first difference and the second difference.

That is, the control method of the present disclosure may be a method of controlling an optical system including the projection device (the projection device 120 of the projector 10(1)) including the projection lens and the drawing element including the plurality of drawing pixels, the first camera (the first imaging device 130 of the projector 10(1)) including the first imaging lens and the first imaging element including the plurality of first imaging pixels, and the second camera (the imaging device 130 of the projector 10(2)) including the second imaging lens and the second imaging element including the plurality of second imaging pixels, and may be a control method including: causing the projection device 120 to project the structured light based on the drawn image drawn on the drawing element onto the projection target object SC; acquiring the first captured image by causing the imaging device 130 of the projector 10(1) to image the structured light projected on the projection target object SC; acquiring the second captured image by causing the imaging device 130 of the projector 10(2) to image the structured light projected on the projection target object SC; identifying, based on the first captured image and the second captured image, a correspondence relationship in which the plurality of first imaging pixels and the plurality of second imaging pixels are associated with each other; calculating, based on the correspondence relationship, a first normal vector as a candidate of a normal vector of the projection target object SC and a second normal vector different from the first normal vector; calculating a first difference as a difference between the first normal vector and the optical axis of the first imaging lens, and a second difference as a difference between the second normal vector and the optical axis of the first imaging lens; and identifying, based on the first difference and the second difference, one of the first normal vector and the second normal vector as the normal vector of the projection target object SC.
(5) The projection controller 151, the imaging controller 152, the geometric corrector 153, the image analyzer 154, and the correction value calculator 155 in the embodiment described above are software modules. However, at least one of the projection controller 151, the imaging controller 152, the geometric corrector 153, the image analyzer 154, and the correction value calculator 155 may be a hardware module such as an application specific integrated circuit (ASIC). Even when at least one of the projection controller 151, the imaging controller 152, the geometric corrector 153, the image analyzer 154, and the correction value calculator 155 is the hardware module, the same advantage as that of the embodiment described above is achieved.
(6) In the embodiment described above, the processing device 150 provided to the projector 10 functions as the projection controller 151, the imaging controller 152, the geometric corrector 153, the image analyzer 154, and the correction value calculator 155. However, by installing the program PR1 in advance in an information processing apparatus (for example, a smartphone or a tablet terminal) including a communication device that communicates with the projector 10 and a processing device such as a processor and causing the processing device of the information processing apparatus to operate in accordance with the program PR1, the processing device may function as the projection controller 151, the imaging controller 152, the geometric corrector 153, the image analyzer 154, and the correction value calculator 155.
(7) The program PR1 may be manufactured alone and may be provided for a fee or free of charge. Specific aspects when providing the program PR1 include an aspect in which the program PR1 is provided by being written in a computer-readable recording medium such as a flash ROM and an aspect in which the program PR1 is provided by being downloaded through an electric communication line such as the Internet.

### C. Summary of Present Disclosure

The present disclosure is not limited to the embodiment and the modifications described above and can be implemented in various aspects without departing from the gist of the present disclosure. For example, the present disclosure can also be implemented by the following aspects. Technical features in the embodiment described above corresponding to the technical features in the aspects described below can be replaced or combined as appropriate in order to solve some or all of the problems of the present disclosure or in order to achieve some or all of the advantages of the present disclosure. Further, the technical features thereof can be deleted as appropriate unless described as essential features in the present specification.

The present disclosure will be summarized below as appendices.

### Appendix 1

An aspect of a control method according to the present disclosure is a method of controlling an optical system including a first projection apparatus including a camera, a first projection lens, and a first drawing element including a plurality of first drawing pixels, and a second projection apparatus including a second projection lens, and a second drawing element including a plurality of second drawing pixels, the method including: causing the first projection apparatus to project first structured light based on a first drawn image drawn on the first drawing element onto a target; acquiring a first captured image by causing the camera to image the first structured light projected on the target; causing the second projection apparatus to project second structured light based on a second drawn image drawn on the second drawing element onto the target; acquiring a second captured image by causing the camera to image the second structured light projected on the target; identifying, based on the first captured image and the second captured image, a correspondence relationship in which the plurality of first drawing pixels and the plurality of second drawing pixels are associated with each other; calculating, based on the correspondence relationship, a first normal vector as a candidate for a normal vector of the target and a second normal vector different from the first normal vector; calculating a first difference as a difference between the first normal vector and an optical axis of the first projection lens, and a second difference as a difference between the second normal vector and the optical axis of the first projection lens; and identifying, based on the first difference and the second difference, one of the first normal vector and the second normal vector as the normal vector of the target. According to the control method of the present aspect, even when both the first normal vector and the second normal vector are calculated as the candidates for the normal vector, it is possible to identify an appropriate normal vector by applying the fact that the first projection apparatus is disposed so as to face the target as much as possible.

### Appendix 2

Further, another aspect of the control method of the present disclosure is a method of controlling an optical system including a projection apparatus including a projection lens and a drawing element including a plurality of drawing pixels, and a camera including an imaging lens and an imaging element including a plurality of imaging pixels, the method including: causing the projection apparatus to project structured light based on a drawn image drawn on the drawing element onto a target; acquiring a captured image by causing the camera to image the structured light projected on the target; identifying, based on the captured image, a correspondence relationship in which the plurality of drawing pixels and the plurality of imaging pixels are associated with each other; calculating, based on the correspondence relationship, a first normal vector as a candidate for a normal vector of the target and a second normal vector different from the first normal vector; calculating a first difference as a difference between the first normal vector and an optical axis of the projection lens, and a second difference as a difference between the second normal vector and the optical axis of the projection lens; and identifying, based on the first difference and the second difference, one of the first normal vector and the second normal vector as the normal vector of the target. According to the control method of the present aspect as well, even when both the first normal vector and the second normal vector are calculated as the candidates for the normal vector, it is possible to identify an appropriate normal vector by applying the fact that the projection apparatus is disposed so as to face the target as much as possible.

### Appendix 3

Further, another aspect of the control method of the present disclosure is a method of controlling an optical system including a projection apparatus including a projection lens and a drawing element including a plurality of drawing pixels, a first camera including a first imaging lens and a first imaging element including a plurality of first imaging pixels, and a second camera including a second imaging lens and a second imaging element including a plurality of second imaging pixels, the method including: causing the projection apparatus to project structured light based on a drawn image drawn on the drawing element onto a target; acquiring a first captured image by causing the first camera to image the structured light projected on the target; acquiring a second captured image by causing the second camera to image the structured light projected on the target; identifying, based on the first captured image and the second captured image, a correspondence relationship in which the plurality of first imaging pixels and the plurality of second imaging pixels are associated with each other; calculating, based on the correspondence relationship, a first normal vector as a candidate for a normal vector of the target and a second normal vector different from the first normal vector; calculating a first difference as a difference between the first normal vector and an optical axis of the first imaging lens, and a second difference as a difference between the second normal vector and the optical axis of the first imaging lens; and identifying, based on the first difference and the second difference, one of the first normal vector and the second normal vector as the normal vector of the target. According to the control method of the present aspect as well, even when both the first normal vector and the second normal vector are calculated as the candidates for the normal vector, it is possible to identify an appropriate normal vector by applying the fact that the first camera is disposed so as to face the target as much as possible.

### Appendix 4

In addition, a more preferable aspect of the control method of the present disclosure is the method of controlling the optical system according to any one of (Appendix 1), (Appendix 2), and (Appendix 3), wherein the identifying one of the first normal vector and the second normal vector as the normal vector of the target includes identifying the first normal vector as the normal vector of the target when the first difference is smaller in magnitude than the second difference, and identifying the second normal vector as the normal vector of the target when the second difference is smaller in magnitude than the first difference. According to the present aspect, one of the first normal vector and the second normal vector smaller in difference from the optical axis of the optical apparatus (the projection apparatus or the camera) disposed so as to face the target can be identified as the normal vector of the target.

### Appendix 5

In addition, another preferred aspect of the control method of the present disclosure is the method of controlling the optical system according to any one of (Appendix 1), (Appendix 2), and (Appendix 3), wherein the identifying one of the first normal vector and the second normal vector as the normal vector of the target includes identifying the second normal vector as the normal vector of the target when the first difference is larger in magnitude than the second difference, and identifying the first normal vector as the normal vector of the target when the second difference is larger in magnitude than the first difference. According to the present aspect, one of the first normal vector and the second normal vector smaller in difference from the optical axis of the optical apparatus (the projection apparatus or the camera) directly facing the target can be identified as the normal vector of the target while avoiding the occurrence of the erroneous determination.

### Appendix 6

In addition, still another preferable aspect of the control method of the present disclosure is the method of controlling the optical system according to (Appendix 1), further including calculating a third difference as a difference between the first normal vector and an optical axis of the second projection lens, and a fourth difference as a difference between the second normal vector and the optical axis of the second projection lens, wherein the identifying one of the first normal vector and the second normal vector as the normal vector of the target includes identifying, based on the first difference, the second difference, the third difference, and the fourth difference, one of the first normal vector and the second normal vector as the normal vector of the target. According to the present aspect, the normal vector of the target can be identified from the first normal vector and the second normal vector based on the difference from the optical axis of the first projection apparatus or the optical axis of the second projection apparatus.

### Appendix 7

In addition, still another preferable aspect of the control method of the present disclosure is the method of controlling the optical system according to (Appendix 6), wherein the identifying one of the first normal vector and the second normal vector as the normal vector of the target includes identifying the first normal vector as the normal vector of the target when the first difference or the third difference is smallest in magnitude of the first difference, the second difference, the third difference, and the fourth difference, and identifying the second normal vector as the normal vector of the target when the second difference or the fourth difference is smallest in magnitude. According to the present aspect, one of the first normal vector and the second normal vector that is the smallest in difference from the optical axis of the first projection apparatus or the optical axis of the second projection apparatus can be identified as the normal vector of the target.

### Appendix 8

In addition, still another preferable aspect of the control method of the present disclosure is the method of controlling the optical system according to (Appendix 6), wherein the identifying one of the first normal vector and the second normal vector as the normal vector of the target includes identifying the second normal vector as the normal vector of the target when the first difference or the third difference is largest in magnitude of the first difference, the second difference, the third difference, and the fourth difference, and identifying the first normal vector as the normal vector of the target when the second difference or the fourth difference is largest in magnitude. According to the present aspect, it is possible to identify the normal vector smaller in difference from the optical axis of the first projection apparatus or the optical axis of the second projection apparatus from the first normal vector and the second normal vector as the normal vector of the target while avoiding the occurrence of the erroneous determination.

### Appendix 9

Another preferred aspect of the control method of the present disclosure is the method of controlling the optical system according to (Appendix 1), wherein at least a part of a surface of the target onto which the first structured light and the second structured light are projected is a curved surface. According to the present aspect, even when at least a part of the surface of the target onto which the first structured light and the second structured light are projected is a curved surface, the shape of the target can be identified.

### Appendix 10

Another preferred aspect of the control method of the present disclosure is the method of controlling the optical system according to one of (Appendix 2) and (Appendix 3), wherein at least a part of a surface of the target onto which the structured light is projected is a curved surface. According to the present aspect, even when at least a part of the surface of the target onto which the structured light is projected is a curved surface, the shape of the target can be identified.

1. A method of controlling an optical system including a first projection apparatus including a camera, a first projection lens, and a first drawing element including a plurality of first drawing pixels, and a second projection apparatus including a second projection lens and a second drawing element including a plurality of second drawing pixels, the method comprising:
causing the first projection apparatus to project first structured light based on a first drawn image drawn on the first drawing element onto a target;
acquiring a first captured image by causing the camera to image the first structured light projected on the target;
causing the second projection apparatus to project second structured light based on a second drawn image drawn on the second drawing element onto the target;
acquiring a second captured image by causing the camera to image the second structured light projected on the target;
identifying, based on the first captured image and the second captured image, a correspondence relationship in which the plurality of first drawing pixels and the plurality of second drawing pixels are associated with each other;
calculating, based on the correspondence relationship, a first normal vector as a candidate for a normal vector of the target and a second normal vector different from the first normal vector;
calculating a first difference as a difference between the first normal vector and an optical axis of the first projection lens, and a second difference as a difference between the second normal vector and the optical axis of the first projection lens; and
identifying, based on the first difference and the second difference, one of the first normal vector and the second normal vector as the normal vector of the target.

2. A method of controlling an optical system including a projection apparatus including a projection lens and a drawing element including a plurality of drawing pixels, and a camera including an imaging lens and an imaging element including a plurality of imaging pixels, the method comprising:
causing the projection apparatus to project structured light based on a drawn image drawn on the drawing element onto a target;
acquiring a captured image by causing the camera to image the structured light projected on the target;
identifying, based on the captured image, a correspondence relationship in which the plurality of drawing pixels and the plurality of imaging pixels are associated with each other;
calculating, based on the correspondence relationship, a first normal vector as a candidate for a normal vector of the target and a second normal vector different from the first normal vector;
calculating a first difference as a difference between the first normal vector and an optical axis of the projection lens, and a second difference as a difference between the second normal vector and the optical axis of the projection lens; and
identifying, based on the first difference and the second difference, one of the first normal vector and the second normal vector as the normal vector of the target.

3. A method of controlling an optical system including a projection apparatus including a projection lens and a drawing element including a plurality of drawing pixels, a first camera including a first imaging lens and a first imaging element including a plurality of first imaging pixels, and a second camera including a second imaging lens and a second imaging element including a plurality of second imaging pixels, the method comprising:
causing the projection apparatus to project structured light based on a drawn image drawn on the drawing element onto a target;
acquiring a first captured image by causing the first camera to image the structured light projected on the target;
acquiring a second captured image by causing the second camera to image the structured light projected on the target;
identifying, based on the first captured image and the second captured image, a correspondence relationship in which the plurality of first imaging pixels and the plurality of second imaging pixels are associated with each other;
calculating, based on the correspondence relationship, a first normal vector as a candidate for a normal vector of the target and a second normal vector different from the first normal vector;
calculating a first difference as a difference between the first normal vector and an optical axis of the first imaging lens, and a second difference as a difference between the second normal vector and the optical axis of the first imaging lens; and
identifying, based on the first difference and the second difference, one of the first normal vector and the second normal vector as the normal vector of the target.

4. The method of controlling the optical system according to claim 1, wherein
the identifying one of the first normal vector and the second normal vector as the normal vector of the target includes identifying the first normal vector as the normal vector of the target when the first difference is smaller in magnitude than the second difference, and identifying the second normal vector as the normal vector of the target when the second difference is smaller in magnitude than the first difference.

5. The method of controlling the optical system according to claim 1, wherein
the identifying one of the first normal vector and the second normal vector as the normal vector of the target includes identifying the second normal vector as the normal vector of the target when the first difference is larger in magnitude than the second difference, and identifying the first normal vector as the normal vector of the target when the second difference is larger in magnitude than the first difference.

6. The method of controlling the optical system according to claim 1, further comprising
calculating a third difference as a difference between the first normal vector and an optical axis of the second projection lens, and a fourth difference as a difference between the second normal vector and the optical axis of the second projection lens, wherein
the identifying one of the first normal vector and the second normal vector as the normal vector of the target includes
identifying, based on the first difference, the second difference, the third difference, and the fourth difference, one of the first normal vector and the second normal vector as the normal vector of the target.

7. The method of controlling the optical system according to claim 6, wherein
the identifying one of the first normal vector and the second normal vector as the normal vector of the target includes
identifying the first normal vector as the normal vector of the target when the first difference or the third difference is smallest in magnitude of the first difference, the second difference, the third difference, and the fourth difference, and identifying the second normal vector as the normal vector of the target when the second difference or the fourth difference is smallest in magnitude.

8. The method of controlling the optical system according to claim 6, wherein
the identifying one of the first normal vector and the second normal vector as the normal vector of the target includes
identifying the second normal vector as the normal vector of the target when the first difference or the third difference is largest in magnitude of the first difference, the second difference, the third difference, and the fourth difference, and identifying the first normal vector as the normal vector of the target when the second difference or the fourth difference is largest in magnitude.

9. The method of controlling the optical system according to claim 1, wherein
at least a part of a surface of the target onto which the first structured light and the second structured light are projected is a curved surface.

10. The method of controlling the optical system according to claim 2, wherein
the identifying one of the first normal vector and the second normal vector as the normal vector of the target includes identifying the first normal vector as the normal vector of the target when the first difference is smaller in magnitude than the second difference, and identifying the second normal vector as the normal vector of the target when the second difference is smaller in magnitude than the first difference.

11. The method of controlling the optical system according to claim 3, wherein
the identifying one of the first normal vector and the second normal vector as the normal vector of the target includes identifying the first normal vector as the normal vector of the target when the first difference is smaller in magnitude than the second difference, and identifying the second normal vector as the normal vector of the target when the second difference is smaller in magnitude than the first difference.

12. The method of controlling the optical system according to claim 2, wherein
the identifying one of the first normal vector and the second normal vector as the normal vector of the target includes identifying the second normal vector as the normal vector of the target when the first difference is larger in magnitude than the second difference, and identifying the first normal vector as the normal vector of the target when the second difference is larger in magnitude than the first difference.

13. The method of controlling the optical system according to claim 3, wherein
the identifying one of the first normal vector and the second normal vector as the normal vector of the target includes identifying the second normal vector as the normal vector of the target when the first difference is larger in magnitude than the second difference, and identifying the first normal vector as the normal vector of the target when the second difference is larger in magnitude than the first difference.
